(19) United States
(12) Patent Application Publication
(10) Pub. No.: US 2010/0127491 A1
(43) Pub. Date: May 27, 2010

(54) Laminate Labels

(75) Inventors: George SCHOLL, Spofford, NH (US); Jason WILDER, Troy, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: ELECTRONIC IMAGING MATERIALS, INC., Keene, NH (US)

(21) Appl. No.: 12/626,224

(22) Filed: Nov. 25, 2009

Related U.S. Application Data
(60) Provisional application No. 61/117,731, filed on Nov. 25, 2008.

(51) Int. Cl. B42D 15/00; B26D 1/00; B32B 37/02

(52) U.S. Cl. 283/81; 83/13; 156/277

(57) ABSTRACT

An aspect of the present disclosure relates to a label including a liner having a first surface, a second surface and at least one edge, wherein the second surface is configured to receive an image forming substance; a laminate, disposed on the first surface of the liner, wherein the laminate extends past the at least one edge, forming a frame portion around the liner;

and an adhesive, disposed on at least a portion of the frame portion of the laminate.

### CROSS-REFERENCE TO RELATED APPLICATIONS

The present application claims the benefit of the filing date of U.S. Provisional Application No. 61/117,731, filed on Nov. 25, 2008, the teachings of which are incorporated herein by reference.

### FIELD

The present disclosure relates to laminate labels and a method of making such labels, wherein the labels may include printable liner and a laminate for sealing around a periphery of the liner.

### BACKGROUND

Labels may be used in a number of applications for identification purposes. In a number of these applications, labels may be exposed to relatively high degrees of wear, sun exposure, weather exposure, chemical exposure, exposure to gasses or fluids, and/or other types of exposure. Examples may include library environments, where labels may be exposed to scuffing; or clinical or laboratory environments, where the labels may be exposed to various chemicals or fluids. To protect the labels, laminating materials may be provided over the labels.

### SUMMARY

An aspect of the present disclosure relates to a label. The label may include a liner having a first surface, a second surface and at least one edge, wherein said second surface is capable of receiving an image forming substance. The label may also include a laminate, disposed on the first surface of the liner, wherein the laminate extends past the at least one edge, forming a frame portion around the liner. In addition, the label may include an adhesive, disposed on at least a portion of the frame portion of the laminate.

A further aspect of the present disclosure relates to a method of forming a label. The method may include disposing an adhesive between a first surface of a liner and a laminate, wherein the liner may include the first surface and a second surface capable of receiving an image forming substance. The method may also include cutting the adhesive and the laminate with a first cutter forming a first periphery and cutting the liner with a second cutter forming a second periphery, wherein the laminate extends past at least a portion of the second periphery forming a frame portion around at least a portion of the liner.

Another aspect of the present disclosure relates to a method of applying a label, wherein the method may include applying an image forming substance on a label. The label may include a liner having a first surface, a second surface and at least one edge, wherein said second surface is capable of receiving an image forming substance; a laminate, disposed on the first surface of the liner, wherein the laminate extends past the at least one edge, forming a frame portion around the liner; and an adhesive, disposed on at least a portion of the frame portion of the laminate. The method may also include adhering the frame portion of the label to a surface.

### BRIEF DESCRIPTION OF THE DRAWINGS

The above-mentioned and other features of this disclosure, and the manner of attaining them, may become more apparent and better understood by reference to the following description of embodiments described herein taken in conjunction with the accompanying drawings, wherein:

FIG. 1a illustrates an example of a top view of a label;

FIG. 1b illustrates a cross-sectional view of the label of FIG. 1a;

FIG. 2 illustrates a cross-sectional view of an example of a number of layers forming a label;

FIG. 3a illustrates an example of a top view of labels on a carrier;

FIG. 3b illustrates an example of a cross-sectional view of the labels of FIG. 3a;

FIG. 4 illustrates a top view of an example label including an image or graphics;

FIG. 5a illustrates a side view of a specimen slide with an example of a label;

FIG. 5b illustrates a top view of a specimen slide with an example of a label; and

FIG. 6 illustrates a side view of an example of a label on a substrate.

### DETAILED DESCRIPTION

It is to be understood that this disclosure is not limited in its application to the details of construction and the arrangement of components set forth in the following description or illustrated in the drawings. The embodiments herein are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

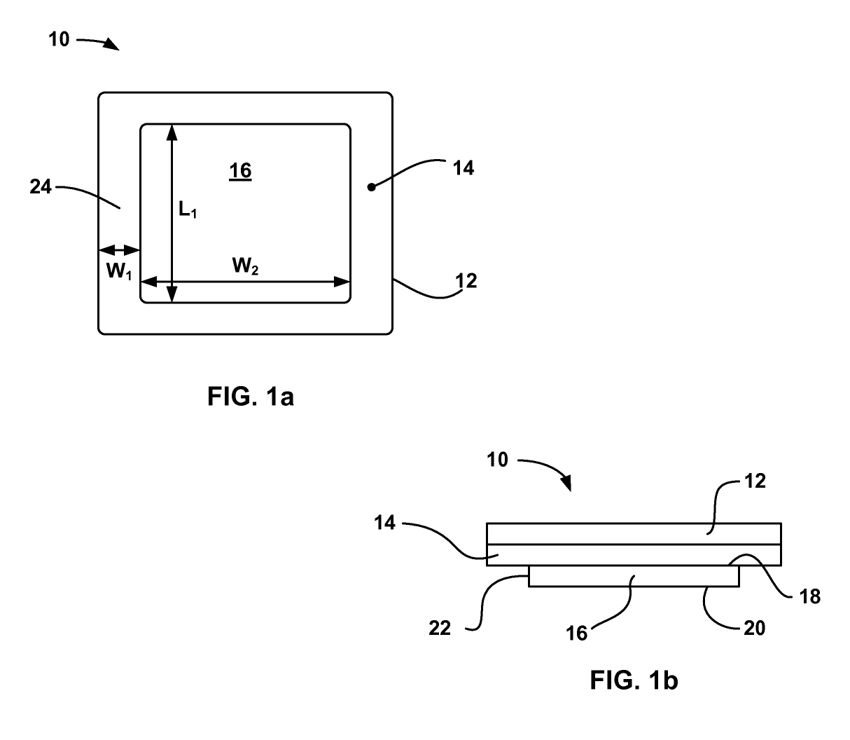

An example of labels contemplated herein is illustrated in FIGS. 1a and 1b, top and cross-sectional views of the label, respectively. The label 10 may include, consist essentially of, or consist of, for example, a laminate 12, an adhesive 14 and liner 16. The liner may include a first surface 18, a second surface 20 and at least one edge 22. The second surface of the liner may be configured to receive an image forming substance. That is, the image forming substance may sufficiently adhere to the second surface either by mechanical or chemical means. For example, there may be some mechanical interlocking of the image forming substance to the second surface. In another example, there may be chemical bonding (such as van der Waals bonding) or reactions between the image forming substance and the second surface. In a further embodiment, the image forming substance may be a coating on the liner that may facilitate thermal printing, changing color on exposure to heat. The illustrated label appears to take on the general configuration of a square; however, as may be appreciated, a number of configurations may be provided, including rectangular, circular, or any shape, or figure, provided that the adhesive and laminate layer form a window or frame 24 about the printable liner.

The liner may include a polymeric material, or other material, that may be printed or otherwise marked upon by inks, toners or other image forming substances. The liner may be a film, which may include thermoplastic materials, paper such as coated kraft paper, or fabric including thermoplastic materials and/or natural materials, etc. The liner may be supplied as a roll or in sheets, which may be continuous in a fan fold configuration or individual sheets. Thermoplastic materials may include polyethylene, polypropylene, polyester, vinyl, acetate, polystyrene, etc. Natural materials may include cotton, cellulose based materials, etc.

In one example, 0% to 99% of incident light in the visible range, i.e., in the range of 350 to 780 nm, including all values and increments therein may pass through the liner. Incident light may be understood as direct light that falls on a surface. Thus, where a relatively high degree of incident light passes though the liner, i.e., 40% or more, the liner may appear somewhat transparent. In addition, depending on the degree of diffusion of light passing through the liner, the liner may also appear relatively translucent.

The liner may be any color, reflecting a portion of incident light in the visible range corresponding to, for example, red, orange, green, blue, indigo, purple and/or various shades, hues, tints and combinations thereof. While, the liner herein may be white, i.e., reflecting substantially all, or at least 90% of incident light in the visible spectrum, including all values and increments in the range of 90% to 99.9%, it may be appreciated that the liner herein need not be white and in some examples are not white. Furthermore, the liner herein may be black in color, absorbing a portion of light, such as greater than 90% of incident light in the visible spectrum, including all values and increments in the range of 90% to 99.9%. In addition, the liner may be combinations of various colors, including black and/or white, and include portions through which varying degrees of light may pass. The liner may have a thickness in the range of 10 to 200 microns, including all values and increments therein.

A primer may be applied to the liner, which may facilitate printing on or marking the liner with various inks, waxes or toners. For example, a primer may include a varnish, such as a radiation curable, heat curable and/or evaporation curable varnish. The varnish may include a drying oil, a resin, polymer, or pre-polymers and/or a thinner or solvent. The drying oil may include for example, linseed oil, walnut oil, tung oil, safflower oil, etc. and may include a relatively high level of polyunsaturated fatty acids. Resin may include naturally derived substances, such as amber, dammar, copal, rosin, sandarac, balsam, etc. Polymers or pre-polymers may include alkyds, acrylics, urethanes, or epoxies. The thinner or solvent may include, for example, turpentine, mineral spirits (a mixture of saturated aliphatic and alicyclic C7 to C12 hydrocarbons with a content between 15 to 30% of C7 to C12 alkyl aromatic hydrocarbons), paint thinner such as acetone, naphtha, toluene, xylene, etc., and/or water. An example of a varnish contemplated herein, may include FILM III extender varnish, available from Environmental Inks and Coatings of Morganton, N.C.

The laminate may include a polymeric material, or other material, that may be printed or otherwise marked upon by inks, toners or other image forming medium. The laminate may be a film, which may include thermoplastic materials, paper, or fabric including thermoplastic materials and/or natural materials, etc. The laminate may be supplied, for example, on a roll or in sheets, including sheets having a continuous fan fold arrangement or individual sheets of a specified length and width. Thermoplastic materials may include polyethylene, polypropylene, polyester, vinyl, acetate, polystyrene, etc. Natural materials may include cotton, cellulose based materials, etc.

In one example, at least 50% of incident light in the visible range, i.e., in the range of 350 to 780 nm, including all values and increments therein may pass through the laminate. The laminate may therefore appear relatively transparent. In addition, depending on the degree of diffusion of light passing through the liner, the liner may also appear relatively translucent.

In another example, the laminate may be any color, reflecting a portion of incident light in the visible range corresponding to, for example, red, orange, green, blue, indigo, purple and/or various shades, hues, tints and combinations thereof. While, the laminate herein may be white, i.e., reflecting substantially all, or at least 90% of incident light in the visible spectrum, including all values and increments in the range of 90% to 99.9%, it may be appreciated that the laminate herein need not be white and in some examples are not white. Furthermore, the laminate herein may be black in color, absorbing a portion of light, such as greater than 90% of incident light in the visible spectrum, including all values and increments in the range of 90% to 99.9%. In addition, the laminate may be combinations of various colors, including black and/or white, and include portions through which varying degrees of light may pass. The laminate may have a thickness in the range of 10 to 200 microns, including all values and increments therein.

As illustrated in FIGS. 1a and 1b, the laminate 12 may extend past at least a portion of the liner periphery, i.e., an edge 22 or the entire periphery of the liner 16. Thus, the laminate may form a frame 24 around the liner 16 or just a portion of the liner 16. The frame may have a width W₁, that is at least 5% of a given dimension of the liner, such as either the length L or width W₂ of the liner, including all values and increments in the range of 5% to 100%, such as 5% to 10%, 5% to 50%, etc. If, for example, the liner is circular in shape, the frame width may be at least 5% of the liner diameter. Thus, if the liner exhibits a length, width or diameter of 1 inch, the width of the frame may be at least 1/20 of an inch. In another example, the width of the frame may be at least 1 mm and up to 50.8 mm, including all values and increments therein.

The adhesive may be a chemically cured or pressure sensitive adhesive. The adhesive may also be crosslinking or non-crosslinking and may include one or more monomers or polymers or copolymers dispersed in one or more solvents. Such monomers or polymers may include natural rubber, polychloroprene, acrylic, silicone, etc., as well as copolymers thereof. Acrylics may include, for example, methacrylate, methyl methacrylate, acrylonitrile, acrylonitrile-butadiene, methyl methacrylate-butadiene-styrene polymer, etc.

The adhesive may be provided in a solvent carrier and applied to either the liner or laminate. Solvent carriers may include, for example, various organic solvents such as relatively short chain hydrocarbons, having between 3 to 20 carbons, including hexane, toluene, ethyl acetate, benzene, N,N-dimethylaniline, etc., as well as monomers, such as acrylic monomer, etc. The adhesive may include in the range of 30 to 60% solids, including all values and increments therein, such as 40 to 50% solids, and/or exhibit a density of 6.0 to 9.0 lb/gallon at 25° C., including all values and increments therein, such as 7.0, 7.3, 7.8, 8.0, 8.2, etc. In addition, the solvents may be present in the adhesive in a range of 20 to 80% by weight of the adhesive, including all values and increments therein, such as 40 to 60% by weight of the adhesive. The adhesive may exhibit a viscosity in the range of 100 cPs to 2×10⁶ cPs at 25° C., including all values and increments therein when applied, such as in the range of 5,000 to 20,000 cPs, or 10,000 to 15,000 cPs. As may be appreciated, the viscosity may increase upon exposure to air and/or heat, allowing any solvents or carriers to evaporate or upon curing or cross-linking of the adhesive. After drying, curing or cross-linking, the viscosity may be in the range of 1×10³ cPs at 25° C. to 1×10²⁰ cPs to a solid at 25° C., where the viscosity may be understood to approach infinity, including all values and increments therein.

The adhesive may also include modifiers, such as tackifiers, viscosity modifiers, curatives, etc. For example, components such as methacrylic acid or acrylic acid may be included in the adhesive. Furthermore, curatives may include amine curatives. The adhesive may have a thickness in the range of 10 to 150 microns, including all values and increments therein. In addition, the adhesive may also exhibit a service range, i.e., a temperature range wherein the adhesive properties may be maintained, of −250° C. to 200° C., including all values and increments therein. The adhesive may also exhibit 180° peel strength, as measure by PSTC-101 (including 1 mil adhesive on 1 mil polyester, bonded to a stainless steel panel), of 1.0 to 4.0 lb per inch, including all values and increments therein, such as 2.5, 2.8, 3.2, etc after a 20 minute bond and 180° peel strength of 2.0 to 5.0 lb per inch, including all values and increments therein, such as 3.0, 3.4, 4.0, 4.4, etc after 24 hours. Furthermore, the adhesive may exhibit a shear resistance as measured by PSTC-107 of 1 to 4 hours, including all increments therein, such as 2 hours under a 1 lb per 0.25 square inch load and a loop tack of 0.7 to 2.0 lb per inch, including all values and increments therein, such as 1.0 lb per inch, 1.1. lb per inch, 1.5 lb per inch, etc. The adhesive may include an acrylic adhesive available from FLEXCON under the product label A-108.

In addition, while the adhesive is illustrated as being disposed continuously between said liner and said laminate, extending past the edges of the liner, the adhesive may be disposed on a portion of the laminate. For example, the adhesive may be disposed around a portion of or around the entire frame portion of the laminate. It may be appreciated that, in one example, the adhesive may be disposed around the periphery of the liner, around the frame portion of the laminate but short of the laminate edge, such that the laminate may extend past the adhesive. In another example, the adhesive may be disposed, not only on the frame portion of the laminate, but also between at least a portion of or all of the laminate and liner. It may be appreciated that the adhesive may also be disposed in various patterns or in random configurations. The adhesive may be applied via a number of coating techniques, including spray coating, dip coating, gravure coating, flexographic printing, offset printing, etc. In another example, the adhesive may be formulated as a film.

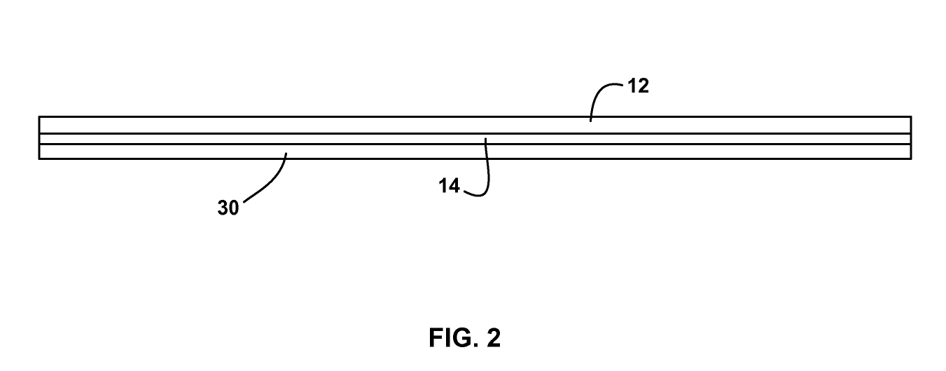

As illustrated in FIG. 2 the labels may be prepared on a carrier 30. The carrier 30 may form the label liners and may be constructed from the liner material. In one example, the adhesive 14 may be applied on the carrier 30 and the laminate 12 may be applied on the adhesive. In another example, the adhesive 14 may be applied on the laminate 12 and the carrier 30 may be applied on the adhesive. It may be appreciated that reference to applied on, may be understood as either direct on or indirect application of the carrier, adhesive or laminate and that interceding layers maybe present.

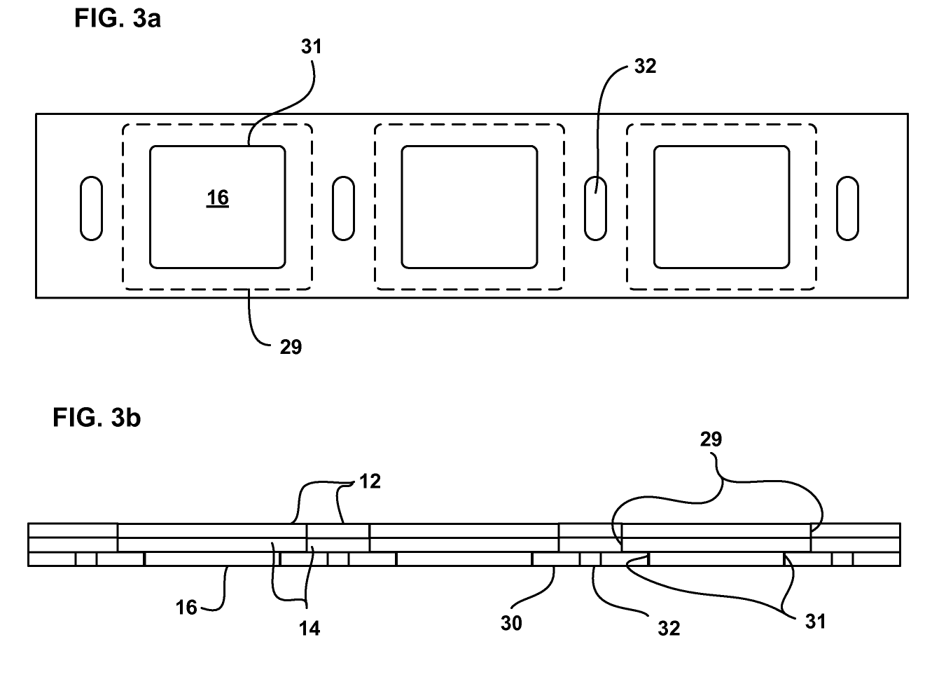

Once the layers forming the labels have been assembled, the individual labels may be cut. Various cutting methods may be used. For example, the labels may be die cut, laser cut, knife cut, etc. Where the labels may be die cut, the dies may be provided on a rotary cylinder or calender roll. In one example, illustrated in FIGS. 3a and 3b, the labels may be cut by more than one die, where a first die may cut the laminate 12, adhesive 14 and optionally, the carrier 30, and the second die may cut the carrier forming the liner 16. The cuts 29 (illustrated in broken lines in FIGS. 3a) and 31 forming or defining the label and boundaries of the liner may include straight cuts (i.e., non perforated cuts), perforated cuts including one or more perforations, and/or tabs, and combinations thereof. The labels may have a thickness in the range of 30 to 400 microns, including all values and increments therein.

In addition, registration marks may be provided. Such registration marks may include openings 32 defined in the carrier 30 and optionally, defined in the adhesive and/or laminate as well. The openings 32 may include a number of shapes, such as the oval or rounded rectangular shapes illustrated in FIG. 3b. Other shapes may be contemplated as well, such as circles, squares, rectangles, etc. Furthermore, in another example, registration marks may be printed on either the liner or the laminate. During printing, the printer may include a sensor, which may detect the registration marks and align the labels in the printer utilizing the marks. For example, the sensor may include an emitter and a detector, when a change in reflectivity is detected by the detector, the printer may recognize that a give portion of the label may be aligned with a given portion of the printing device, such as a print head. In another example, where the registration marks pass through all the label layers, a registration key or protrusion in the printer may be inserted into the registration mark and used to advance the label.

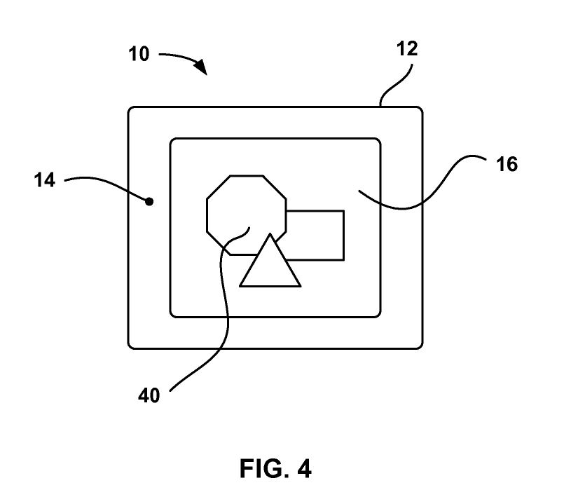

It may be appreciated that the labels may be provided individually or as a group of more than one label on a carrier. The prepared labels may be fed into a printing or image forming device, such as a printer, and patient identification information, barcode identifiers or other graphics (including text or images) may be printed on the liner. In addition, the liner may be written upon using a writing instrument such as a pen, marker, crayon, etc. FIG. 4 illustrates an example of a label 10 having an image forming substance 40 thereon defining various graphics. The label may then be applied to a number of objects.

The labels may withstand exposure to various environments, including exposure to water and/or various chemicals, including xylene, alcohol, hematoxylin, bluing and/or oesin. In addition, the labels may withstand exposure to heat, such as temperatures in the range of 25° C. to 100° C., including all values and increments therein, such as 50° C., 55° C., 60° C., for a given time, such as in the range of a few minutes to a few hours, such as in the range of 2 minutes to 2 hours, including all values and increments therein. Furthermore, the image forming substance, including toner, wax, ink, etc., may also be chosen to withstand presented heat. That is, the image forming substance may include a resin that may begin to exhibit a relatively substantial decrease in viscosity, i.e., a decrease in the range of 100 cPs or more, upon exposure to such elevated temperatures.

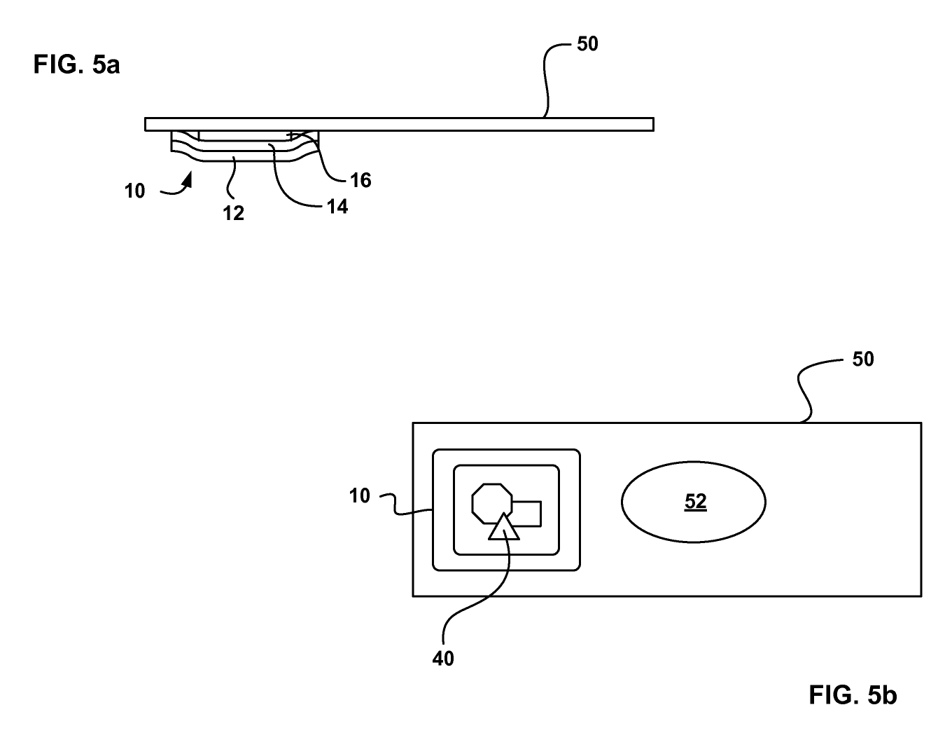

In one example, illustrated in FIGS. 5a and 5b, the label may be placed on the bottom surface (or top surface) of a specimen slide 50. The specimen slide may include, for example, a biological sample 52 mounted thereon. The image forming substance 40 defining graphics may be visible through the specimen slide and the liner material may be sealed between the laminate and the specimen slide, protecting the image forming substance from chemicals or solvents (including water) that may adversely affect the image forming substance.

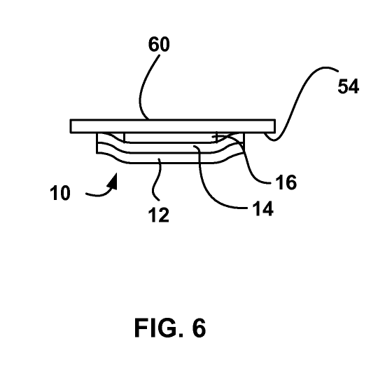

Accordingly, it may be appreciated that in an another example, as illustrated in FIG. 6, the labels 10 may include or consist of a liner 16 including a surface upon which the liner 16 may be printed 20. In addition, a layer of adhesive 14 may be supplied to affix the label 10 to a surface 54 of a substrate 60. The adhesive may also serve to affix the liner 16 to the laminate 12. It may be appreciated that in some examples, a single layer of adhesive may be used to both adhere the label to a surface and to affix the liner to the laminate. The printed surface of the liner 20 may directly or indirectly contact the substrate surface 54 and in an example of a system embodied herein, at least a portion of the printed surface or a portion of incident light reflected by the printed surface or light emitted by the printed surface may be visible through the substrate 60. For example, in one embodiment 10% or more of light reflected or emitted by the label may be visible through the substrate 60. In addition, portions of the adhesive 14 may contact the laminate 12, the liner 16 and the substrate surface 54.

Furthermore, referring back to FIG. 3a and FIG. 3b, the labels 10 may be included on a sheet or roll, such that the carrier 30 and liner 16 portion of the carrier form a printable surface. The labels 10 including the liner 16 may be removed from the carrier 30 once the printing process has been completed. In addition, excess laminate and/or adhesive material surrounding the labels 10 may be removed prior to or after printing.

It may be appreciated that the above may provide a design that may be viewed through clear materials such as glass or plastic. In addition, printing on the liner and including a laminate of dimensions relatively larger than the liner keeps the information printed on the liner protected from the surrounding environment. This may especially be the case with the selection of adhesives and laminate materials based on the end applications. Furthermore, while there may be other ways of creating such “window stickers,” the concept of printing on the liner itself allows for the use of a single material for providing the “printable region” and the liner rather than two materials providing a printable region and the liner. As may be appreciated, other “window stickers” may include an opaque printable material as well as a laminate as well as a liner. Combining the printable material and the liner into a single liner including a printable surface reduces manufacturing costs as well as material costs.

The foregoing description of several methods and embodiments has been presented for purposes of illustration. It is not intended to be exhaustive or to limit the claims to the precise steps and/or forms disclosed, and obviously many modifications and variations are possible in light of the above teaching. It is intended that the scope of the invention be defined by the claims appended hereto.

What is claimed is:

1. A label comprising:
a liner having a first surface, a second surface and at least one edge;
a laminate, disposed on said first surface of said liner, wherein said laminate extends past said at least one edge, forming a frame portion around said liner; and
an adhesive, disposed on at least a portion of said frame portion of said laminate.

2. The label of claim 1, wherein said second surface of said liner is configured to receive an image forming substance.

3. The label of claim 1, wherein said laminate includes a laminate surface and said laminate surface is configured to receive an image forming substance.

4. The label of claim 1, further comprising a primer applied to said second surface of said liner.

5. The label of claim 1, wherein said adhesive is disposed between said liner and said laminate.

6. The label of claim 1, wherein said frame portion has a width and said width is at least 5% of a given dimension of the liner.

7. The label of claim 1, wherein said frame portion has a width of at least 1 mm.

8. The label of claim 1, wherein at least 50% of incident light having at least one wavelength in the range of 350 nm to 780 nm may pass through said laminate.

9. The label of claim 1, further comprising a carrier, wherein said liner is defined in said carrier.

10. The label of claim 9, wherein said carrier includes at least one registration mark.

11. A method of forming a label comprising:
disposing an adhesive between a first surface of a liner and a laminate, wherein said liner includes said first surface and a second surface, said second surface configured to receiving an image forming substance;
cutting said adhesive and said laminate with a first cutter forming a first periphery; and
cutting said liner with a second cutter forming a second periphery, wherein said laminate extends past at least a portion of said second periphery forming a frame portion around at least a portion of said liner.

12. The method of claim 11, further comprising forming a registration mark in said liner.

13. The method of claim 12, wherein said registration mark is formed with said second cutter.

14. The method of claim 11, further comprising disposing a primer on said liner.

15. The method of claim 11, further comprising printing on said second surface of said laminate.

16. A method of applying a label, comprising:
applying an image forming substance on a label, wherein said label includes a liner having a first surface, a second surface and at least one edge wherein said second surface is configured to receive an image forming substance, a laminate, disposed on said first surface of said liner, wherein said laminate extends past said at least one edge, forming a frame portion around said liner, and an adhesive, disposed on at least a portion of said frame portion of said laminate; and
adhering said frame portion of said label to a surface.

17. The method of claim 16, wherein applying an image forming substance comprises printing on said label.

18. The method of claim 16, further comprising applying an image forming substance on said laminate.

19. The method of claim 16, wherein said label further comprises a carrier and a registration mark defined in said carrier.

20. The method of claim 19, further comprising aligning said label in a printer using said registration mark.
